(19) United States
(12) Patent Application Publication
(10) Pub. No.: US 2017/0117609 A1
(43) Pub. Date: Apr. 27, 2017

(54) METAL BASE HIGH EFFICIENCY ANTENNA

(71) Applicant: INPAQ TECHNOLOGY CO., LTD., Miaoli County (TW)

(72) Inventor: Yen-Ming CHEN, Taipei City (TW)

(21) Appl. No.: 15/210,955

(22) Filed: Jul. 15, 2016

(30) Foreign Application Priority Data
Oct. 23, 2015 (TW) 104134776

(51) Int. Cl. H01Q 1/22; H01Q 1/38; H01Q 1/48

(52) U.S. Cl. CPC H01Q 1/2275; H01Q 1/48; H01Q 1/38

(57) ABSTRACT

A metal base high efficiency antenna, it is preferably formed as a ceramic fine peace, and suitable for installed to the connector inside an electronic appliance, such that the connector has functions of antenna, in addition, since the connector is mostly arranged at a space near the surface of electronic appliance, the radiation efficiency of antenna would not be interfered by the metallic elements inside the electronic appliance.

### BACKGROUND OF THE INVENTION

1. Field of the Invention

The present invention relates to a metal base high efficiency antenna, particularly to an ceramic antenna monomer can be provided onto a connector of an electronic appliance, such that the connector has functions of antenna, and the signal transmission of antenna would not be interfered by the metal material inside the electronic appliance.

2. Description of the Related Art

A conventional electronic appliance must be provided with an antenna to achieve wireless receiving or wireless communication. Generally, the antenna is formed directly on a circuit board of the electronic appliance, or as a rod-like body, which is inserted from the outside of the electronic appliance and then connected to a ground terminal of the circuit board on the electronic appliance for signal transmission.

As shown in FIG. 1, in a conventional electronic appliance 1A, an end of a circuit board (not shown) is provided with a ground terminal 1C. An external antenna 1B is connected to the ground terminal 1C through a transmission line 1D, providing the electronic appliance 1A with functions of wireless signal transmission.

However, with the increasing diversity of devices in various types of electronic appliances, not only the slim and compact design is required, but also a number of metallic elements (e.g. metal enclosure) are provided to products to enhance product quality. In response to the antenna efficiency, a circuit board would leave a space for the antenna as a clearance area, but this design would result in poor utilization efficiency of a product's motherboard. Moreover, as a result of the design of electronic appliance towards miniaturization, there is less and less clearance area for an internal antenna, further limiting functions of the antenna. Thus, most antennas only have single-frequency operation capabilities. However, as the market is getting mature and increased, if the antenna being provided only has a single-frequency operation capability, its operational capacity and market competitiveness would be significantly inadequate. Additionally, to maintain the appearance and quality of the product, the antenna would be limited to a certain space. All these may result in the circumstance that the appearance and antenna efficiency could not be taken into account at the same time.

### SUMMARY OF THE INVENTION

Accordingly, it is an objective of the present invention to provide a metal base high efficiency antenna, which is served as a ceramic antenna monomer integrally joined with a connector, such that the connector is equipped with the antenna function.

According to the metal base high efficiency antenna of the present invention, since said connector is mostly provided at the outer surface of an electronic appliance, a ceramic antenna monomer integrally joined with the connector can avoid interference from metallic elements of electronic appliances, which affects signal transmission. This is another objective of the present invention.

According to the metal base high efficiency antenna of the present invention, the ceramic antenna monomer is produced by low temperature cofired ceramic, and is constituted as a particle fine piece, such that it can be easily provided on any metallic elements of electronic appliances to provide the metallic elements with the antenna function. This is another objective of the present invention.

According to the metal base high efficiency antenna of the present invention, the ceramic antenna monomer may be installed to the connector, such that the connector has the signal emission and transmission capability due to the mounting of the antenna body. The internal space of the electronic appliance can be planned more effectively because there is no need to additionally design space for an antenna. This is another objective of the present invention.

According to the metal base high efficiency antenna of the present invention, the ceramic antenna monomer may also integrally joined with an electronic communication interface such as a HDMI (High Definition Multimedia Interface) connector, USB (Universal Serial Bus), or Com Port (Communication Port), such that the electronic communication interface such as HDMI connector, USB, or Com Port has the signal emission and transmission capability. This is a further objective of the present invention.

According to the metal base high efficiency antenna of the present invention, when the ceramic antenna monomer integrally joined with an electronic communication interface such as a connector or a HDMI connector, since the electronic communication interface such as the HDMI connector, USB, or Com Port is usually arranged at a space near the outer surface of the electronic appliance, as the antenna is integrated with the element, the element surface can be used for radiation. Therefore, the signal transmission efficiency can be significantly enhanced. This is a further objective of the present invention.

The objective, shape, configuration means, characteristics and effects of the present invention will be apparent with reference to the following description in conjunction with the accompanying drawings.

### BRIEF DESCRIPTION OF THE DRAWINGS

FIG. 1 is a schematic view showing a conventional electronic appliance externally connected to an antenna;

FIG. 2 is an exploded perspective view of a metal base high efficiency antenna of the present invention;

FIG. 3 is a perspective view showing the assembly of a metal base high efficiency antenna according to the present invention;

FIG. 4 is a schematic view of a metal base high efficiency antenna according to a first embodiment of the present invention; and

FIG. 5 is a schematic view of a metal base high efficiency antenna according to a second embodiment of the present invention the present invention.

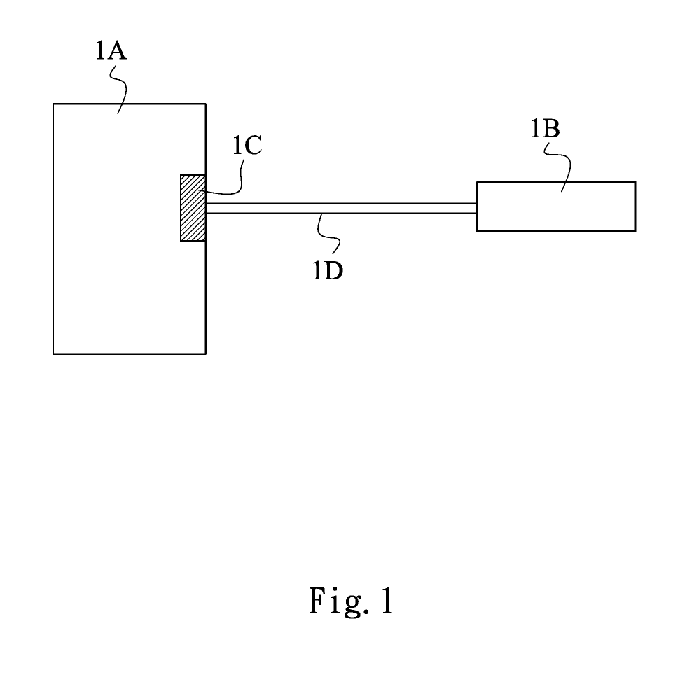

### DETAILED DESCRIPTION OF THE PREFERRED EMBODIMENT

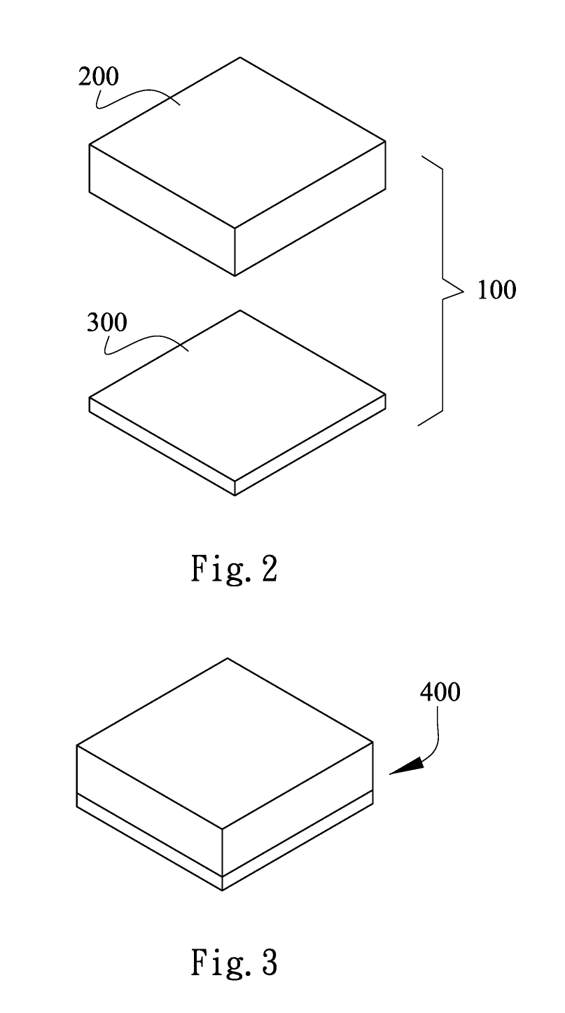

In the metal base high efficiency antenna according to the present invention, as shown in FIG. 2, the antenna 100 includes an antenna body 200, and a base 300 for placing the antenna body 200. Specifically, the antenna body 200 is made up of wiring for antenna layout and ceramic material for covering the antenna as a bulk ceramic antenna. The antenna body 200 can be assembled with the base 300 to be a bulk ceramic antenna monomer 400 (as shown in FIG. 3).

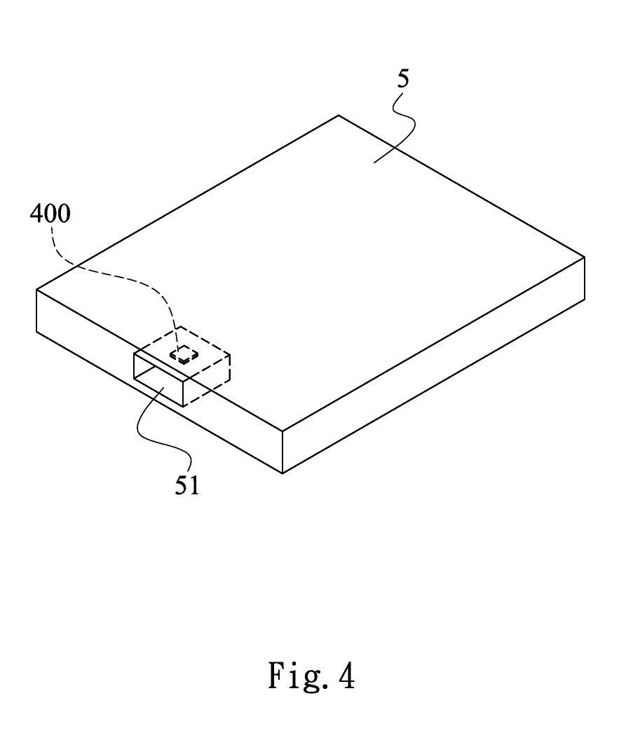

Please refer to FIG. 4. When the metal base high efficiency antenna of the present invention is implemented, the ceramic antenna monomer 400 including the antenna body 200 and the base 300 can be installed to a female connector 51 inside an electronic appliance 5. Through the connection of the female connector 51 and a circuit board inside the electronic appliance 5, the female connector 51 has functions of antenna with signal transmission and receiving capability.

When the metal base high efficiency antenna of the present invention is implemented, the ceramic antenna monomer 400 including the antenna body 200 and the base 300 may be provided to a HDMI (High Definition Multimedia Interface) connector of a television, such that the HDMI connector has functions of antenna with signal transmission and receiving capability; or on the USB (Universal Serial Bus) of other communication product such as a personal computer or a mobile device; or on an electronic communication interface such as a Com Port (Communication Port).

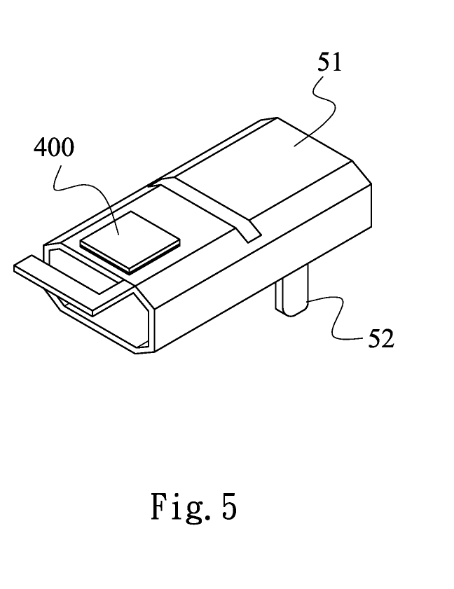

Please refer to FIG. 5. When the ceramic antenna monomer 400 including the antenna body 200 and the base 300 is installed to the connector 51, the ceramic antenna monomer 400 is integrated with the connector 51 through the two-shot injection molding technology or Laser Direct Structuring (LDS). After a pin 52 at an end of the connector 51 is connected to a circuit element of an electronic appliance, the circuit is conducted while the function of antenna with signal transmission and receiving capability is provided.

After an actual test, the metal base high efficiency antenna in the present invention can obtain the following result:

| Frequency | Peak gain | Efficiency |
|---|---|---|
| 2400 | 0.19 | 38.1 |
| 2410 | 1.24 | 47.11 |
| 2420 | 1.34 | 50.25 |
| 2430 | 1.79 | 54.28 |
| 2440 | 1.91 | 58.24 |
| 2450 | 2.1 | 60.08 |
| 2460 | 2.56 | 62.41 |
| 2470 | 2.74 | 64.06 |
| 2480 | 2.32 | 59.17 |
| 2490 | 2.21 | 57.05 |
| 2500 | 2.12 | 56.15 |
| 5100 | 3.21 | 83.34 |
| 5200 | 2.58 | 72.78 |
| 5300 | 2.29 | 73.39 |
| 5400 | 2.64 | 69.26 |
| 5500 | 2.72 | 66.05 |
| 5600 | 2.71 | 66.87 |
| 5700 | 2.7 | 61.63 |
| 5800 | 3.07 | 70.78 |

As described above, the metal base high efficiency antenna in the present invention certainly has an unprecedented innovative structure, which is not found in any publication. Also, there are no similar products in the market. Therefore, the metal base high efficiency antenna possesses novelty undoubtedly. In addition, the present invention has unique features and functionality far from the others in the art. It is indeed more inventive than the others in the art, and meets the requirements of the application requirements of the new patent law. Accordingly, the patent application has been filed in accordance with patent law.

The described embodiments are only for illustrative and exemplary, and that various changes and modifications may be made to the described embodiments without departing from the scope of the invention as disposed by the appended claims.

What is claimed is:

1. A metal base high efficiency antenna, comprising an antenna body and a base for installing the antenna body, which is characterized in that: the antenna body is made up of wiring for antenna layout and ceramic material for covering the antenna as a bulk ceramic fine peace, and the antenna body is assembled with the base to be a bulk ceramic antenna monomer.

2. The metal base high efficiency antenna as claimed in claim 1, wherein the ceramic antenna monomer is provided onto a female connector of the electronic appliance, such that the female connector has functions of antenna with signal transmission and receiving capability.

3. The metal base high efficiency antenna as claimed in claim 2, wherein the ceramic antenna monomer is provided onto the connector through two-shot injection molding technology or Laser Direct Structuring (LDS).

4. The metal base high efficiency antenna as claimed in claim 1, wherein the ceramic antenna monomer is provided onto an electronic communication interface such as the HDMI (High Definition Multimedia Interface) connector, USB (Universal Serial Bus) or a Com Port (Communication Port) of an electronic appliance, such that the electronic communication interface such as the HDMI connector has functions of antenna with signal transmission and receiving capability.

5. The metal base high efficiency antenna as claimed in claim 2, wherein the ceramic antenna monomer is provided onto an electronic communication interface such as the HDMI (High Definition Multimedia Interface) connector, USB (Universal Serial Bus) or a Com Port (Communication Port) of an electronic appliance, such that the electronic communication interface such as the HDMI connector has functions of antenna with signal transmission and receiving capability.

6. The metal base high efficiency antenna as claimed in claim 3, wherein the ceramic antenna monomer is provided onto an electronic communication interface such as the HDMI (High Definition Multimedia Interface) connector, USB (Universal Serial Bus) or a Com Port (Communication Port) of an electronic appliance, such that the electronic communication interface such as the HDMI connector has functions of antenna with signal transmission and receiving capability.
